(19) United States
(12) Patent Application Publication
(10) Pub. No.: US 2004/0032528 A1
(43) Pub. Date: Feb. 19, 2004

(54) Method and apparatus for controlling transitions between electronic program guide modes

(75) Inventors: Chul-jun Park, Suwon-si (KR); Jung-a Kim, Seoul (KR); Seong-wook Kho, Seoul (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/426,014

(22) Filed: Apr. 30, 2003

(30) Foreign Application Priority Data
Aug. 19, 2002 (KR) 2002-48968

(51) Int. Cl. H04N 5/50; G06F 3/00; H04N 5/445; G06F 13/00

(52) U.S. Cl. 348/563; 348/731; 725/39; 725/52

(57) ABSTRACT

A method and apparatus for controlling transitions among electronic program guide (EPG) modes are provided. The method includes (a) determining whether a predetermined key value for a mode transition is input while any one of the EPG modes is displayed, and (b) whenever such a predetermined key value for a mode transition is input in (a), controlling transitions among the EPG modes so that the EPG modes can be sequentially changed from one mode to another in accordance with a predetermined sequential order. Thus, since the EPG modes can be directly changed from one mode to another through simple key operations and without disabling the currently enabled EPG mode, it is possible to reduce the number of keys on a key input device. Further, usability can be improved since the EPG mode transitions can be achieved through the simple operations of fewer keys.

### BACKGROUND OF THE INVENTION

This application claims the priority of Korean Patent Application No. 2002-48968, filed on Aug. 19, 2002, in the Korean Intellectual Property Office, the disclosure of which is incorporated herein in its entirety by reference.

1. Field of the Invention

The present invention relates to a method and apparatus for controlling electronic modes of a television (TV), and more particularly, to a method and apparatus for controlling transitions among a plurality of electronic program guide (EPG) modes where the EPG modes can be directly changed from one mode to another through simple key input operations.

2. Description of the Related Art

As data processing technologies are particularly developing in the field of televisions, broadcasting stations are becoming able to transmit various kinds of additional information, including general information on TV programs, together with video and audio signals, and users can receive through TV receivers and utilize such additional information for many purposes.

In other words, typical analog broadcasting systems transmit a very limited amount of additional information. Thus, it has not been possible to provide users with various services because the additional information is inserted and transmitted in predetermined intervals of horizontal synchronization signals, which cause no effects to the picture screen. However, recently developed digital broadcasting systems can transmit large amounts of additional information for users' conveniences. Such additional information includes not only general information on TV programs but also information regarding education, games, on-line commercial transactions, etc., and the coverage of the additional information is inclined to increase.

Usually, a digital TV adopts a function to display available programs using additional information called electronic program guide (EPG) information. The EPG information can be edited and displayed in various modes, such as a mini EPG mode for selectively displaying EPG information of a selected channel, a full EPG mode for displaying the entirety of the EPG information of every channel, etc., in accordance with developers' data processing technologies.

Conventionally, a transition from one EPG mode to another among the various EPG modes has been made either by using keys of a key input device in correspondence with the respective EPG modes or by selecting an EPG mode through a hierarchical EPG menu system.

In regards to the key based EPG mode transition, if there are two EPG modes, e.g., an EPG mode A and an EPG mode B, the keys are operated as shown in FIG. 1A to change the present screen displaying the EPG mode A to a different screen displaying the EPG mode B. That is, the currently displayed EPG mode A is disabled initially by pressing a predetermined key, e.g., an EXIT key on a remote controller, and then the EPG mode B is enabled through a predetermined EPG mode set-up process. Therefore, the conventional key based EPG mode transition is somehow cumbersome.

Meanwhile, in regards to the hierarchical EPG menu based transition, the present EPG mode, e.g., the EPG mode A cannot be directly changed to a different EPG mode, e.g., the EPG mode B. In this case, an upper level menu must be called first and then the EPG mode B is selected through the upper level menu as shown in FIG. 1B.

As described above, the conventional key based EPG mode transition has problems in that users need to inconveniently operate keys a number of times to change EPG modes and manufacturers need to provide a number of keys in correspondence with the respective EPG modes and mode transition functions. The conventional hierarchical EPG menu based transition also has problems in terms of usability in that a current EPG mode cannot be directly changed to a different mode, and an upper level menu must necessarily and inconveniently be called first to change modes.

### SUMMARY OF THE INVENTION

The present invention provides a method and apparatus for controlling transitions among a plurality of electronic program guide (EPG) modes, in which the EPG modes can be directly changed from one mode to another through simple key operations.

According to an aspect of the present invention, there is provided a method of controlling transitions among a plurality of electronic program guide (EPG) modes in a television (TV). The method includes the steps of (a) determining whether a predetermined key value for a mode transition is input while any one of the EPG modes is displayed, and (b) whenever the predetermined key value for a mode transition is input in step (a), controlling the transitions among the plurality of EPG modes so that the plurality of EPG modes can be sequentially changed from one mode to another in accordance with a predetermined sequential order.

According to another aspect of the present invention, there is provided an apparatus for controlling transitions among a plurality of electronic program guide (EPG) modes in a television (TV), which includes a broadcasting signal receiving unit for selecting and demodulating only such broadcasting signals that correspond to a selected channel from received broadcasting signals in accordance with a channel control signal; an EPG storing unit for storing EPG information included in the broadcasting signals received through the broadcasting signal receiving unit; a graphic processing unit for processing the EPG information read from the EPG storing unit and outputting the processed EPG information graphically in correspondence with the plurality of EPG modes; and a controller for implementing a control process corresponding to an input key instruction. The controller controls the transitions among the plurality of EPG modes so that the plurality of EPG modes can be sequentially changed from one mode to another in accordance with a predetermined sequential order while any one of the EPG modes is displayed and whenever a predetermined key value for a mode transition is input, reading from the EPG storing unit and editing EPG information corresponding to a changed EPG mode, and providing the edited EPG information to the graphic processing unit.

### BRIEF DESCRIPTION OF THE DRAWINGS

The above aspects and advantages of the present invention will become more apparent by describing in detail illustrative, non-limiting embodiments thereof with reference to the attached drawings in which:

FIGS. 1A and 1B are diagrams for explaining conventional methods of controlling transitions between EPG modes;

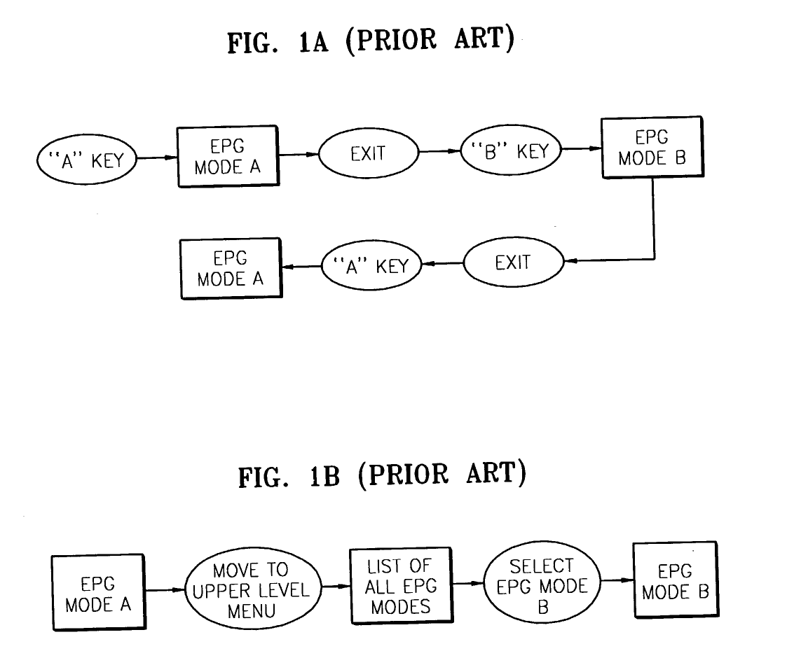

FIG. 2 is a block diagram of an apparatus for controlling transitions among a plurality of EPG modes according to the present invention;

FIG. 3 is a flowchart of a method of controlling transitions among a plurality of EPG modes according to an exemplary embodiment of the present invention;

FIG. 4 is a flowchart of a method of controlling transitions among a plurality of EPG modes according to another exemplary embodiment of the present invention; and

FIGS. 5A through 5C are diagrams for explaining a method of controlling transitions among a plurality of EPG modes according to the present invention.

### DETAILED DESCRIPTION OF THE INVENTION

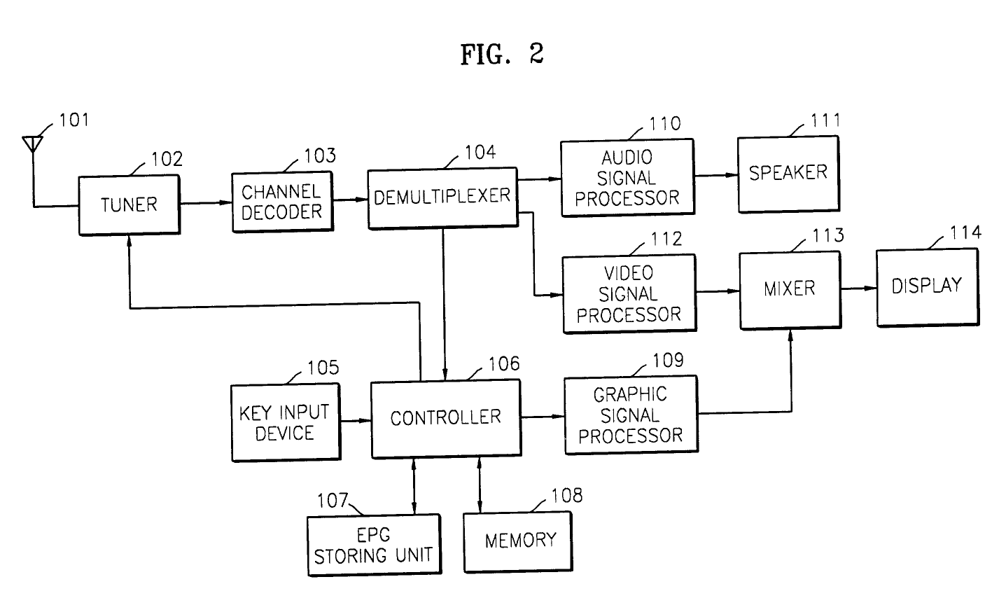

Referring to FIG. 2, an apparatus for controlling transitions among a plurality of EPG modes in a television according to the present invention includes an antenna 101, a tuner 102, a channel decoder 103, a demultiplexer 104, a key input device 105, a controller 106, an EPG storing unit 107, a memory 108, a graphic signal processor 109, an audio signal processor 110, a speaker 111, a video signal processor 112, a mixer 113, and a display device 114.

First, basic operations of the apparatus shown in FIG. 2 will be described.

When a TV is powered on and a channel is selected using keys of the key input device 105, the tuner 102 receives a channel control signal from the controller 106 and, in accordance with the channel control signal, selects such broadcasting signals that correspond to the selected channel from broadcasting signals received through the antenna 101. The selected broadcasting signals are output to the channel decoder 103. Then, the channel decoder 103 recovers digital signals detected from the selected broadcasting signals in the unit of packets and outputs the recovered digital broadcasting signals to the demultiplexer 104. The demultiplexer 104 separates audio data, video data, and additional information data from the recovered digital broadcasting signals and outputs the separated audio, video, and additional information data in different series of bits.

The separated audio data is decoded and converted to analog signals via the audio signal processor 110, and the converted analog audio signals are ultimately output through the speaker 111.

Meanwhile, the separated video data is decoded and subjected to signal processing, such as error corrections, via the video signal processor 112. The decoded video data is mixed with graphic signals to be displayed in an on-screen display window via the mixer 113, and the mixed signals are ultimately output via the display device 114.

The additional information data separated by the demultiplexer 104 includes electronic program guide (EPG) information. The EPG information is input to the controller 106 and is processed by the controller 106 as follows.

First, the controller 106 updates the existing EPG information stored in the EPG storing unit 107 with the new EPG information included in the currently received additional information data.

Then, the controller 106 controls the EPG storing unit 107 and the graphic signal processor 109 so that EPG data corresponding to an EPG mode selected in accordance with an input key instruction is read from the EPG storing unit 107 and is output in an edited graphic screen corresponding to the selected EPG mode via the graphic signal processor 109.

In this exemplary embodiment, the EPG modes include, for example, a Full EPG mode, a Mini EPG mode, and a Quick EPG mode. The Full EPG mode is defined as a mode displayed as a full screen table having columns for indicating channels, rows for indicating time zones, and cells for indicating information on a program available at a corresponding channel and corresponding time zone. The Mini EPG mode is a mode displayed on a corner of the screen in a small scale to provide information on programs of a selected channel and the broadcasting times thereof. The Quick EPG mode is a mode in which information on programs of different channels at the present time is displayed on the left side of the screen and information on programs recommended by broadcasting stations is displayed on the lower portion of the screen.

The controller 106 implements control processes corresponding to key values input through the key input device 105. Particularly, in a case where an input key value corresponds to a guide key value, the controller 106 enables a default EPG mode. Here, the default EPG mode can be optionally determined in accordance with a user's preference.

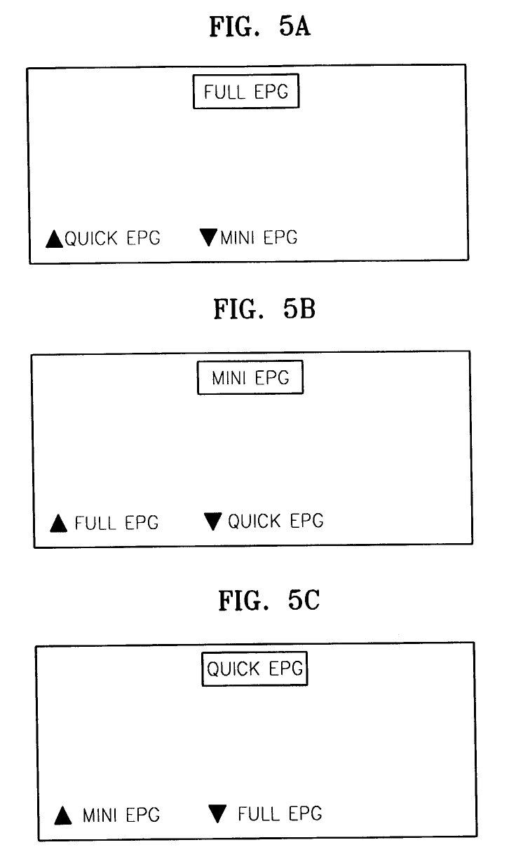

For example, if a user determines a Full EPG mode as a default EPG mode, EPG data is processed and output in correspondence with specifications of the Full EPG mode as shown in FIG. 5A. In addition to the EPG data corresponding to the Full EPG mode, key guide information is output enabling the EPG modes to be sequentially changed from one mode to another, e.g., from the Full EPG mode to the Quick EPG mode or to the Mini EPG mode. In this exemplary embodiment, the controller 106 controls transitions among the EPG modes using, e.g., up ▴ and down ▾ keys so that the EPG modes are sequentially changed whenever the up or down key value is input.

That is, the Full EPG mode shown in FIG. 5A can be directly changed to the Quick EPG mode shown in FIG. 5C or to the Mini EPG mode shown in FIG. 5B by inputting the up or down key value in the Full EPG mode shown in FIG. 5A. If the down key value is consecutively input twice in the Full EPG mode shown in FIG. 5A, the mode is sequentially changed to the Mini EPG mode and then the Quick EPG mode.

While the controller 106 can be designed to unlimitedly allow transitions from one EPG mode to another regardless of completing a sequence of available EPG modes, it is also possible to design the controller 106 to automatically disable the EPG mode once completing the sequence of available EPG modes.

The memory 108 stores a control program for the controller 106 and data required for controlling the EPG mode transitions.

The key input device 105 includes a plurality of keys to operate a television. A typical remote control can be used as the key input device 105.

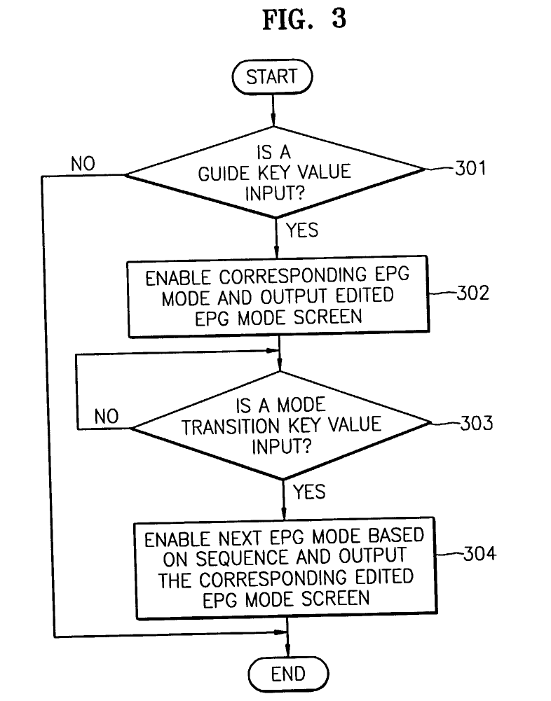

Now, a method of controlling transitions among a plurality of EPG modes according to an exemplary embodiment of the present invention will be described with reference to FIG. 3 together with FIGS. 2 and 5A-5C.

The controller 106 discriminates whether a guide key value to enable an EPG mode is input from the key input device 105 (STEP 301).

If it is determined in STEP 301 that the guide key value is input, a default EPG mode is enabled. As described above, the default EPG mode can be determined in accordance with a user's preference. As the default EPG mode is enabled, EPG information corresponding to the default EPG mode is read from the EPG storing unit 107. The EPG information read from the EPG storing unit 107 is adequately edited to form a picture screen to correspond with the enabled EPG mode, and the edited screen is output (STEP 302). The key guide information to sequentially change the enabled EPG mode to other EPG modes is simultaneously output together with the EPG information, as shown in FIGS. 5A to 5C. As described above, a user can directly change the currently enabled EPG mode to other EPG modes using the key guide information.

Thereafter, it is determined whether a predetermined mode transition key value, e.g., a key value corresponding to an up or down key, is input while a certain EPG mode is enabled and its corresponding EPG menu screen is displayed (STEP 303).

Whenever a predetermined mode transition key value is input in STEP 303, the enabled EPG mode is sequentially changed to another mode in accordance with a predetermined sequence, and the EPG data corresponding to the sequentially changed EPG mode is read from the EPG storing unit 107 and is edited and output via the picture screen (STEP 304). That is, as shown in FIGS. 5A to 5C, the Full EPG mode can be directly changed to the Quick EPG mode or to the Mini EPG mode respectively when the up or down key value is input in the Full EPG mode. If the down key value is consecutively input twice in the Full EPG mode, the mode is sequentially changed to the Mini EPG mode and then to the Quick EPG mode.

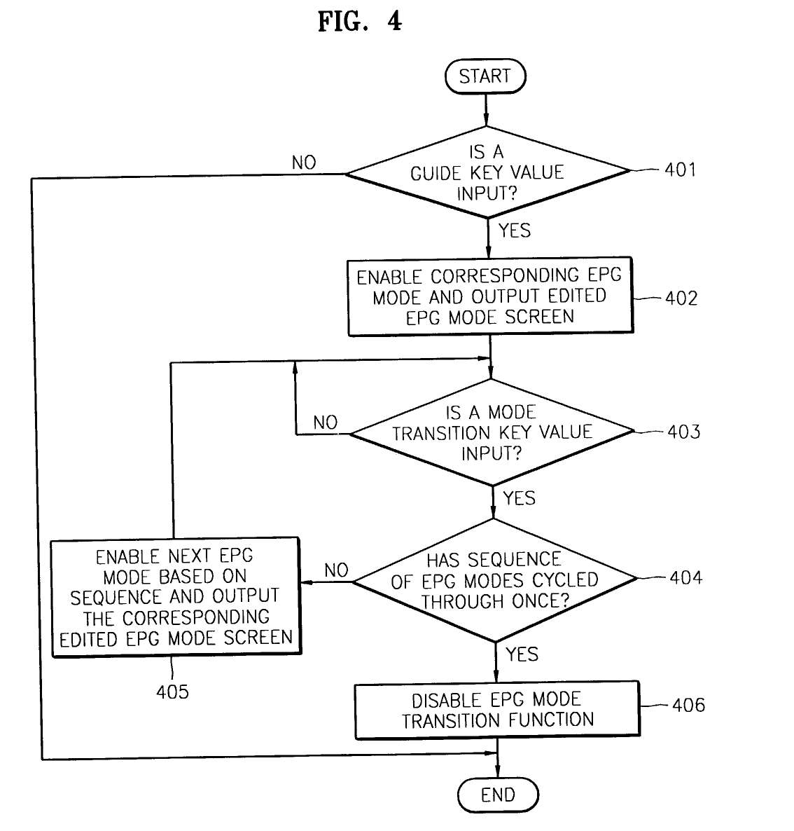

FIG. 4 is a flowchart of a method for controlling transitions among a plurality of EPG modes according to another exemplary embodiment of the present invention.

Since STEPS 401 through 403 in FIG. 4 are identical to the STEPS 301 through 303 in FIG. 3, detailed descriptions of the STEPS 401 through 403 in FIG. 4 are omitted.

If a predetermined mode transition key value is input in STEP 403, it is determined whether the predetermined sequence of the EPG modes is completed (STEP 404). That is, it is determined whether a sequence of the Full EPG mode, the Mini EPG mode, and the Quick EPG mode has once completed.

If it is determined in STEP 404 that the predetermined sequence has not yet been completed, the EPG mode is sequentially changed to other modes in accordance with the predetermined sequence, and the EPG data corresponding to the sequentially changed EPG mode is read from the EPG storing unit 107, edited, and then output via the picture screen (STEP 405).

However, if it is determined in STEP 404 that the predetermined sequence has completed once, the EPG mode transition function is disabled and normal broadcasting screens are displayed (STEP 406).

As described above, according to the present invention, a plurality of EPG modes can be directly changed from one mode to another through simple key operations and without disabling the currently enabled EPG mode. Accordingly, it is possible to reduce the number of keys on a key input device. Further, usability can be improved since the EPG mode transitions can be achieved through simple operations using fewer keys.

The present invention can be implemented on a recording medium that is readable by a computer. The recording medium that can be read by a computer may include any kind of recording device in which data that is readable by the computer is stored. Examples of the recording medium include ROM, RAM, CD-ROM, magnetic tape, hard disks, floppy disks, flash memory, optical data storage devices, and even carrier waves, for example, transmissions over the Internet. Moreover, the recording medium may be distributed among computer systems that are interconnected through a network, and the present invention may be stored and implemented as code in the distributed system.

The present invention has been particularly shown and described with reference to illustrative, non-limiting embodiments thereof, and it will be understood by those of ordinary skill in the art that various changes in form and details may be made therein without departing from the spirit and scope of the present invention as defined by the appended claims.

What is claimed is:

1. A method of controlling transitions among a plurality of electronic program guide (EPG) modes in a television (TV), comprising the steps of:
(a) determining whether a predetermined key value for a mode transition is input while any one of the EPG modes is enabled; and
(b) whenever the predetermined key value for a mode transition is input in step (a), controlling transitions among the EPG modes so that the EPG modes can be sequentially changed from one mode to another in accordance with a predetermined sequence.

2. The method of claim 1, wherein the enabled EPG mode is displayed with key guide information through which the currently enabled EPG mode is sequentially changed to at least one other EPG mode in accordance with the predetermined sequence.

3. The method of claim 1, further comprising the step of automatically disabling the transitions among the EPG modes when the predetermined sequence has completed once.

4. The method of claim 3, wherein a normal broadcasting screen is displayed on the TV when the transitions are automatically disabled.

5. The method of claim 1, further comprising when a predetermined key value corresponding to a guide key value is input, enabling a default EPG mode.

6. The method of claim 5, wherein said default EPG mode is determined based on a user's preference.

7. An apparatus for controlling transitions among a plurality of electronic program guide (EPG) modes in a television (TV), comprising:
a broadcasting signal receiving unit selecting and demodulating only broadcasting signals that correspond to a selected channel from received broadcasting signals in accordance with a channel control signal;
an EPG storing unit storing EPG information included in the broadcasting signals received through the broadcasting signal receiving unit;
a graphic processing unit processing the EPG information read from the EPG storing unit and outputting the processed EPG information as graphics in correspondence with the plurality of EPG modes; and
a controller implementing a control process corresponding to an input key instruction, controlling transitions among the EPG modes so that the EPG modes can be sequentially changed from one EPG mode to another EPG mode in accordance with a predetermined sequential order while any one of the EPG modes is displayed and whenever a predetermined key value for a mode transition is input, reading the EPG information corresponding to a changed EPG mode from the EPG storing unit, editing the read EPG information and providing the edited EPG information to the graphic processing unit.

8. The apparatus of claim 7, wherein an enabled EPG mode is displayed with key guide information through which the currently enabled EPG mode is sequentially changed to at least one other EPG mode in accordance with the predetermined sequence.

9. The apparatus of claim 7, wherein the controller implements a control process to automatically disable the transitions among the EPG modes when the predetermined sequence has completed once.

10. The apparatus of claim 9, wherein a broadcasting screen corresponding to the selected channel is displayed on the TV when the transitions are automatically disabled by the control process.

11. The apparatus of claim 7, further comprising when a predetermined key value corresponding to a guide key value is input, the controller enables a default EPG mode.

12. The apparatus of claim 11, wherein said default EPG mode is determined based on a user's preference.
